(19) United States
(12) Patent Application Publication
(10) Pub. No.: US 2014/0063689 A1
(43) Pub. Date: Mar. 6, 2014

(54) DIELECTRIC MATERIAL TO ENHANCE CAPACITANCE OF A CAPACITOR

(71) Applicant: CHRISTOPHER LORNE BLAIR, SAN JOSE, CA (US)

(72) Inventor: CHRISTOPHER LORNE BLAIR, SAN JOSE, CA (US)

(21) Appl. No.: 14/016,935

(22) Filed: Sep. 3, 2013

Related U.S. Application Data
(60) Provisional application No. 61/743,379, filed on Sep. 4, 2012.

(51) Int. Cl. H01G 4/06

(52) U.S. Cl. CPC H01G 4/06; B82Y 99/00
USPC 361/311; 977/734

(57) ABSTRACT

A dielectric material suitable for use between electrodes of a capacitor includes dipole-impregnated fullerenes able to increase a dielectric constant of the dielectric material in order to enhance the energy storage capacity of the capacitor is provided. The dielectric material includes buckminsterfullerenes each having a dipole molecule impregnated within the buckminsterfullerene, the dipole molecules within the buckminsterfullerenes able to rotate and align with forces of an electric field when in the presence of the electric field so that, when in use between the electrodes of the capacitor, they counteract the electric field between the electrodes and increase the energy storage capacity of the capacitor.

### RELATED APPLICATION

The application claims priority to provisional patent application U.S. Ser. No. 61/743,379 filed on Sep. 4, 2012, the entire contents of which is herein incorporated by reference.

### BACKGROUND

The embodiments herein relate generally to capacitors and their electrical charge storage capacity.

The use of capacitors to store electric energy in a broad range of applications is well documented. Individuals continue to seek ways to improve the capacitance and electric charge storage ability of these capacitors. A capacitor with an enhanced capacitance will benefit any industry as the device will increase the performance and operating capacity of an electrical system. As such, there is a high demand for capacitors with a higher capacitance. For example, electric car manufacturers have a need for an improved energy storage device that will make the cars more competitive in terms of range and convenience with gasoline powered cars. It is understood that the benefits of a capacitor with a better capacitance per volume are not limited to energy storage uses, but may apply to any electronic circuit, particularly those where compact size is beneficial.

The capacitance of a capacitor is determined by the area of the plates, the distance between the plates and the dielectric constant. While each of these variables affects the capacitance of the capacitor, it is noteworthy that a dielectric material with a higher dielectric constant can yield a capacitor with a considerably higher energy storage capacity. Current systems to increase the capacitance of the capacitor vary the area of the plates, the distance between the plates and the material of the dielectric. However, these systems do not use fullerenes (“buckyballs”) impregnated with dipole molecules in the dielectric material to effectively increase the dielectric constant of the material and the overall capacitance of a capacitor. Also, due to their size and structure, and properties as nanomaterials, they promise an ancillary benefit of very thin (on the order of nanometers) layering, and with it, a smaller distance between the plates (electrodes).

As such, there is a need in the industry for a dielectric material for use between electrodes of a capacitor that comprises fullerenes impregnated with dipole molecules to increase the dielectric constant of the material and the overall energy storage capacity of the capacitor.

### SUMMARY

A dielectric material suitable for use between electrodes of a capacitor is provided. The material comprises impregnated fullerenes configured to increase a dielectric constant of the dielectric material in order to enhance the energy storage capacity of the capacitor. The dielectric material comprises a plurality of buckminsterfullerenes each comprising a dipole molecule impregnated within the buckminsterfullerenes, the buckminsterfullerenes configured to restrict the translational movement of the dipole impregnated buckminsterfullerenes and their interaction with other neighboring atoms or molecules, the dipole molecules within the buckminsterfullerenes being configured to rotate and align with forces of an electric field when in the presence of the electric field so that, when in use between the electrodes of the capacitor, they counteract the electric field between the electrodes and increase the energy storage capacity of the capacitor.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a schematic view of certain embodiments of the invention;

FIG. 2 depicts a schematic view of certain embodiments of the invention;

FIG. 3 depicts a schematic view of certain embodiments of the invention in the presence of an electric field;

FIG. 4 depicts a schematic view of an alternative embodiment of the invention; and

FIG. 5 depicts a schematic view of an alternative embodiment of the invention.

### DETAILED DESCRIPTION OF CERTAIN EMBODIMENTS

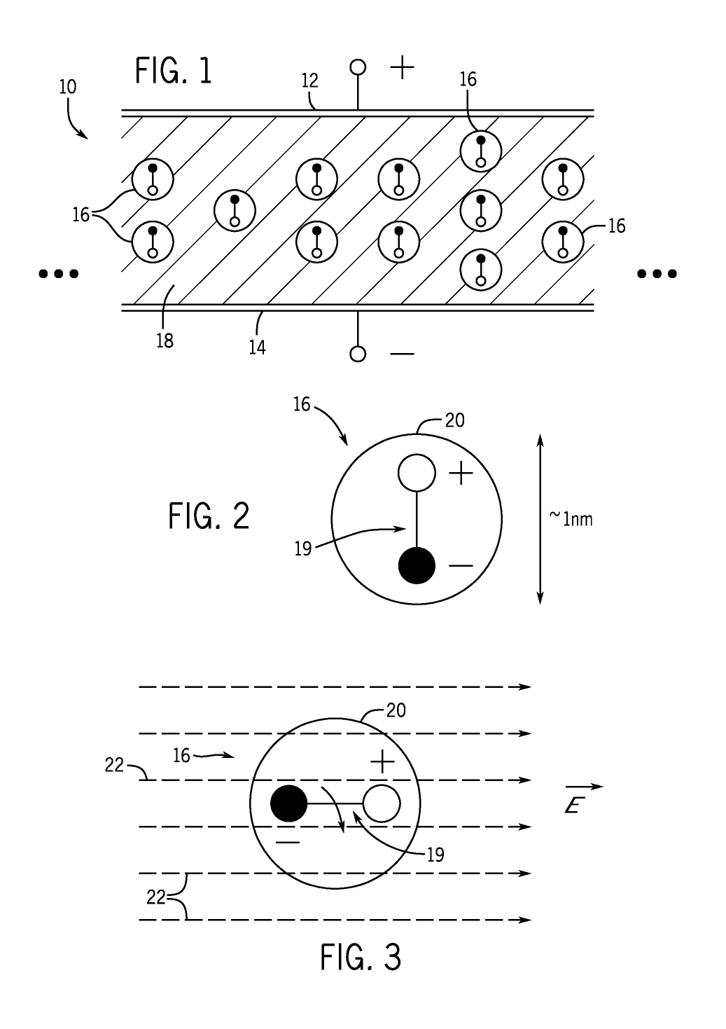

FIGS. 1 and 2 depict certain embodiments of the dielectric material. The dielectric material 18 comprises a plurality of spherical buckminsterfullerenes 20, also known as C₆₀ molecules, which are impregnated with dipole molecules 19 to form dipole impregnated buckminsterfullerenes 16. Dielectric material 18 may comprise solely of the dipole impregnated buckminsterfullerenes 16 or the dipole impregnated buckminsterfullerenes 16 suspended in a medium such as a gas, liquid, solid, plasma, suspension or gel. Dielectric material 18 is configured to be placed between anode 12 and cathode 14 of capacitor 10.

In certain embodiments of the invention, dipole molecules 19 are molecules with high electric dipole moments. These dipole molecules 19 may include either NaCl, which has a relatively high dipole moment of 10 debyes, or KCl. However, it should be understood that any type of dipole molecule may be used to impregnate buckminsterfullerenes 20. The spherical buckminsterfullerenes 20 act as a shell around dipole molecules 19 and allows them to spin. However, the shell restricts the translational movement of the dipole impregnated buckminsterfullerenes and their interaction with other neighboring atoms or molecules.

The dipole impregnated buckminsterfullerenes 16 are created using any known techniques in the field such as laser ablation, heating and/or electrolysis. In laser ablation, a laser is directed to a block of carbon such as graphite when in the presence of dipole molecules. This forms the dipole impregnated buckminsterfullerenes 16, which are used to form dielectric material 18. Dipole impregnated buckminsterfullerenes 16 are applied to an electrode, either anode 12 or cathode 14, of capacitor 10 using a technique such as chemical vapor deposition. The remaining electrode is attached to dielectric material 18 such that the dipole impregnated buckminsterfullerenes 16 are sandwiched between anode 12 and cathode 14. It should be understood that any techniques known in the field may be used to create dielectric material 18 and assemble capacitor 10.

It shall be appreciated that in an ideal scenario, dielectric material 18 consists solely of dipole impregnated buckminsterfullerenes 16. This maximizes the dielectric constant of dielectric material 18 and the overall energy storage capacity of capacitor 10. However, for a practical matter, dielectric material 18 may comprise dipole impregnated buckminsterfullerenes 16 suspended or immersed in an electrically inert medium such as a gas, liquid, solid, plasma, suspension or gel. This will change the dielectric constant of the material and may lower the overall energy storage capacity of capacitor 10. Suspending the dipole impregnated buckminsterfullerenes in a medium may make the fabrication process of assembling the dielectric material between the electrodes easier and more practical.

FIG. 3 depicts certain embodiments of dipole molecules 19, as components of dielectric material 18, in use. When dielectric material 18 of capacitor 10 is in the presence of electric field forces 22, dipole molecules 19 of buckminsterfullerenes 20 rotate and align with electric field forces 22. It shall be appreciated that buckminsterfullerenes 20 isolate dipole molecules 19 and allow them to rotate freely when influenced by the electric field forces 22. Dipole molecules 19 may rotate within buckminsterfullerenes 20 or also cause the buckminsterfullerenes to rotate. As dipole molecules 19 align with the electric field, electric field forces 22 are counteracted and reduced. This results in a dielectric material with a high dielectric constant and an increased energy storage capacity of the capacitor.

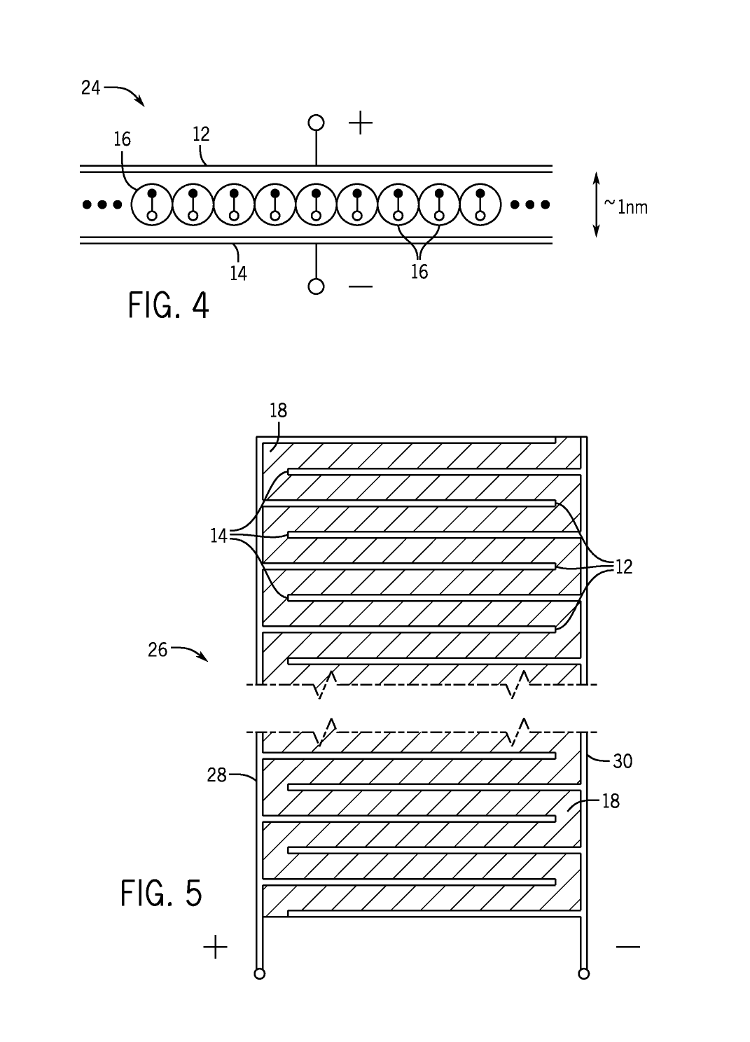

FIG. 4 depicts an alternative embodiment 24 of the invention. In this configuration, dipole impregnated buckminsterfullerenes 16 are placed between anode 12 and cathode 14 in one layer. Although the dielectric constant of dielectric material 18 is the same, this configuration decreases the distance between the electrodes to approximately 1 nm, which helps to achieve a higher overall energy storage capacity of capacitor 10. It shall be understood that it may be difficult to assemble dipole impregnated buckminsterfullerenes 16 in one layer and multiple layers of the molecules may be required during the fabrication of the capacitor.

FIG. 5 depicts an alternative embodiment 26 of the invention. In this configuration, dielectric material 18 is placed between multiple anodes 12 and cathodes 14 within positive electrodes structure 28 and negative electrodes structure 30. Stacking the anodes and cathodes in this manner help to maximize the overall energy storage capacity of the capacitor.

It shall be appreciated that the components of the dielectric material described in several embodiments herein may comprise any alternate materials known in the field and be of any color, size and/or dimensions. This allows the dielectric material to accommodate any type of capacitor. It is understood that the dielectric material in the capacitor is not limited to energy storage uses, but may be used in alternative applications such as a RF filter.

Persons of ordinary skill in the art may appreciate that numerous design configurations may be possible to enjoy the functional benefits of the inventive systems and compositions. Thus, given the wide variety of configurations and arrangements of embodiments of the present invention the scope of the invention is reflected by the breadth of the claims below rather than narrowed by the embodiments described above.

What is claimed is:

1. A dielectric material suitable for use between electrodes of a capacitor, the material comprising impregnated fullerenes configured to increase a dielectric constant of the dielectric material in order to enhance the energy storage capacity of the capacitor, the dielectric material comprising a plurality of buckminsterfullerenes each comprising a dipole molecule impregnated within the buckminsterfullerenes, the buckminsterfullerenes configured to restrict the translational movement of the dipole impregnated buckminsterfullerenes and their interaction with other neighboring atoms or molecules, the dipole molecules within the buckminsterfullerenes being configured to rotate and align with forces of an electric field when in the presence of the electric field so that, when in use between the electrodes of the capacitor, they counteract the electric field between the electrodes and increase the energy storage capacity of the capacitor.

2. A capacitor comprising a cathode and an anode, the capacitor further comprising the dielectric material of claim 1.

3. The dielectric material of claim 1, wherein the dipole molecule comprises NaCl or KCl.

4. The dielectric material of claim 1, wherein the plurality of impregnated buckminsterfullerenes are suspended in a medium.

5. The dielectric material of claim 4, wherein the medium is a gas, liquid, solid, plasma, suspension or gel.
